(19) United States
(12) Patent Application Publication
(10) Pub. No.: US 2025/0162846 A1
(43) Pub. Date: May 22, 2025

(54) SHEAVE DEVICE RETRACTING AND UNFOLDING METHOD

(71) Applicant: KOBELCO CONSTRUCTION MACHINERY CO., LTD., Hiroshima-shi (JP)

(72) Inventors: Takao ETO, Hyogo (JP); Eiji MIYA, Hyogo (JP); Tadahiro SHIMIZU, Hyogo (JP)

(73) Assignee: KOBELCO CONSTRUCTION MACHINERY CO., LTD., Hiroshima-shi (JP)

(21) Appl. No.: 18/841,724

(22) PCT Filed: Mar. 9, 2023
(86) PCT No.: PCT/JP2023/009010

§ 371 Date: Aug. 27, 2024

(30) Foreign Application Priority Data
Mar. 17, 2022 (JP) 2022-042064

(51) Int. Cl. B66C 23/82; B66C 23/42; B66C 23/90

(52) U.S. Cl. CPC B66C 23/82; B66C 23/42; B66C 23/905

(57) ABSTRACT

A sheave device retracting and unfolding step includes winding and unwinding a rope by a winch, with a lifting side sheave device lifted by an assist crane. A tension information detecting step includes detecting rope state information on the rope when the sheave device retracting and unfolding step is performed. A tension information using step includes performing at least one of notification to a worker and drive control of the winch based on the rope state information detected in the tension information detecting step

### TECHNICAL FIELD

The present invention relates to a sheave device retracting and unfolding method for retracting and unfolding a sheave device of a crane.

### BACKGROUND ART

For example, Patent Literature 1 describes retracting a lifting side sheave device (upper spreader in Patent Literature 1) (paragraph 0007 of Patent Literature 1). In the technology described in Patent Literature 1, with the lifting side sheave device (upper spreader) lifted by an assist crane, a winch gradually winds a rope while applying tension to the rope. This causes the lifting side sheave device (upper spreader) to be retracted.

When retracting the lifting side sheave device, if the speed of winding the rope by the winch is not properly adjusted with respect to the moving speed of the lifting side sheave device by the assist crane, there is a risk that the tension of the rope becomes excessively high. In addition, there is a similar problem when unfolding the lifting side sheave device from the retracted state.

### CITATION LIST

### Patent Literature

Patent Literature 1: JP 2021-130562 A

### SUMMARY OF INVENTION

Therefore, an object of the present invention is to provide a sheave device retracting and unfolding method that can suppress the tension of the rope from becoming excessively high when retracting and unfolding the lifting side sheave device.

The sheave device retracting and unfolding method is used for a crane. The crane includes a rope, a winch that winds and unwinds the rope, and a lifting side sheave device including a sheave on which the rope is hung. The sheave device retracting and unfolding method includes a sheave device retracting and unfolding step, a tension information detecting step, and a tension information using step. The sheave device retracting and unfolding step includes winding and unwinding the rope by the winch, with the lifting side sheave device lifted by an assist crane. The tension information detecting step includes detecting rope state information on the rope when the sheave device retracting and unfolding step is performed. The tension information using step includes performing at least one of notification to a worker and drive control of the winch based on the rope state information detected in the tension information detecting step.

With the above configuration, it is possible to suppress the tension of the rope from becoming excessively high when retracting and unfolding the lifting side sheave device.

### BRIEF DESCRIPTION OF DRAWINGS

FIG. 1 is a view of a crane of a sheave device retracting and unfolding system that performs a sheave device retracting and unfolding method, viewed from a lateral direction.

FIG. 2 is a view of the crane viewed from a lateral direction when the lifting side sheave device shown in FIG. 1 is retracted and unfolded.

FIG. 3 is a block diagram showing a functional configuration of the sheave device retracting and unfolding system shown in FIG. 1.

FIG. 4 is a flowchart showing an operation of the sheave device retracting and unfolding system shown in FIG. 1.

FIG. 5 is a view corresponding to FIG. 2 of a third embodiment.

FIG. 6 is a view corresponding to FIGS. 1 and 2 of a fourth embodiment.

FIG. 7 is a view corresponding to FIGS. 1 and 2 of a fifth embodiment.

### DESCRIPTION OF EMBODIMENTS

### First Embodiment

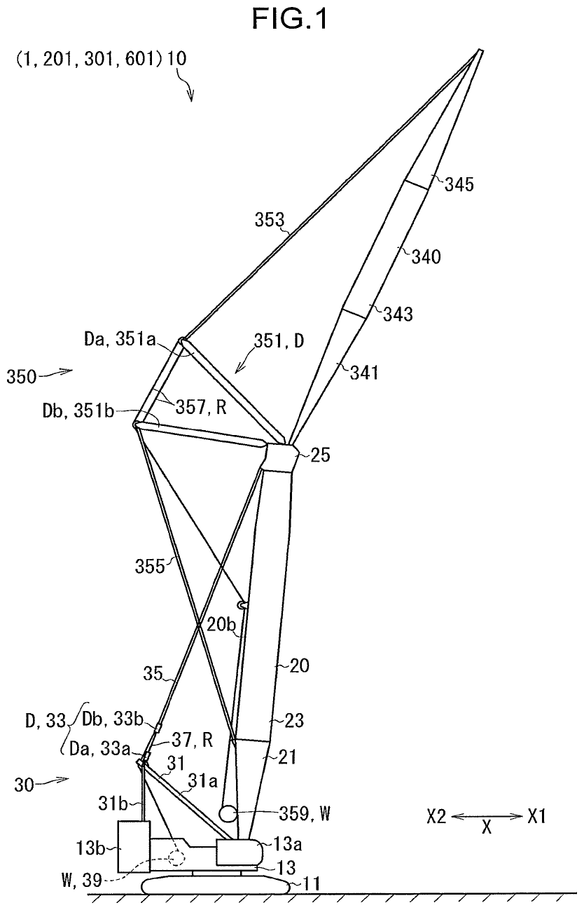

With reference to FIGS. 1 to 4, a sheave device retracting and unfolding method according to a first embodiment and a sheave device retracting and unfolding system 1 used for the method will be described.

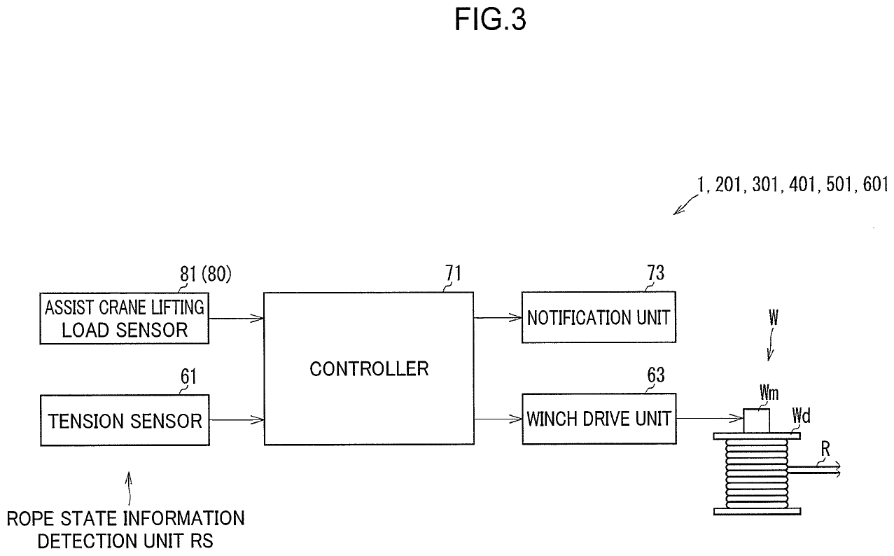

The sheave device retracting and unfolding system 1 is a system that assists in at least one of retracting and unfolding a sheave device D shown in FIG. 1. The sheave device retracting and unfolding system 1 may be a system that automatically performs at least one of retracting and unfolding the sheave device D. The sheave device retracting and unfolding system 1 includes a crane 10, a controller 71 shown in FIG. 3, a notification unit 73, and an assist crane 80.

The crane 10 is a machine that performs work by using a boom 20 (derricking member) or the like, as shown in FIG. 1. The crane 10 is, for example, a construction machine that performs construction work. The crane 10 includes a lower body 11, an upper slewing body 13, the boom 20, and a boom derricking device 30. Note that a jib 340 (derricking member) and a jib derricking device 350 shown in FIG. 1 will be described later. The jib 340 and the jib derricking device 350 may not be provided in the present embodiment.

The lower body 11 supports the upper slewing body 13. The lower body 11 may be a structure fixed to the ground or may be capable of traveling. The crane 10 may be a fixed crane or a mobile crane. If the lower body 11 is capable of traveling, that is, if the lower body 11 is a lower travelling body, the lower body 11 may include crawlers or wheels.

The upper slewing body 13 is slewably mounted on the lower body 11. The boom 20 or the like is attached to the upper slewing body 13. The upper slewing body 13 includes a cab 13a and a counterweight 13b. The cab 13a is a part in which a worker (operator) can operate the crane 10. The crane 10 may be operated by the operator inside the cab 13a, may be operated remotely by an operator outside the crane 10, or may be automatically operated by the controller 71 (see FIG. 3). The counterweight 13b is a weight for balancing the crane 10 in a front-rear direction. The direction in which the axis of rotation of the upper slewing body 13 relative to the lower body 11 extends is defined as the up-down direction. The direction in which the axis of rotation of the boom 20 relative to the upper slewing body 13 extends is defined as the lateral direction. The direction orthogonal to each of the up-down direction and the lateral direction is defined as the front-rear direction X. In the front-rear direction X, the side from the counterweight 13b toward the attachment portion of the boom 20 to the upper slewing body 13 is defined as the front side X1, and the opposite side is defined as the rear side X2.

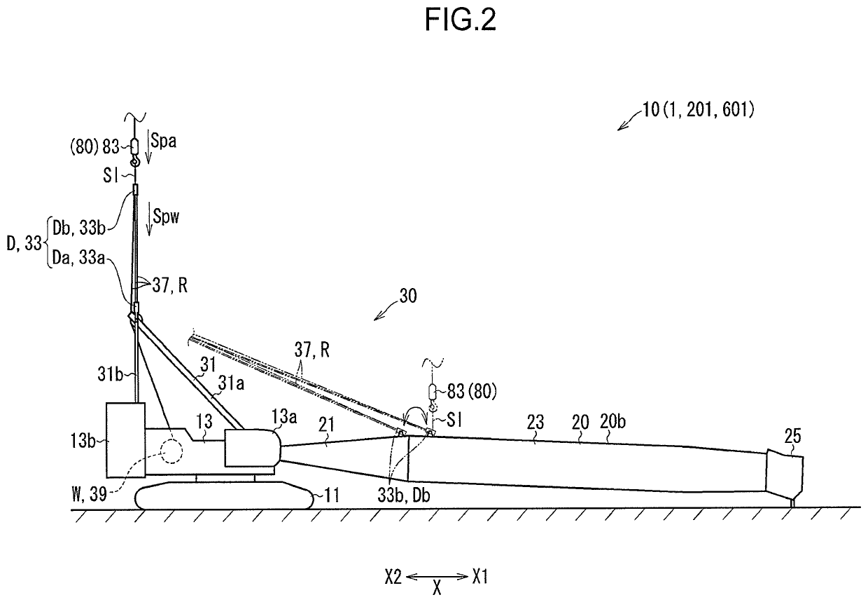

The boom 20 (derricking member) is attached to the upper slewing body 13 so as to be raisable and lowerable (rotatable in the up-down direction). The “derricking member” is a member that is attached to a structure of the crane 10 (for example, upper slewing body 13 or the like) so as to be raisable and lowerable. The boom 20 can take a posture in which the boom is lowered (collapsed posture) such that the central axis of the boom 20 extending in the longitudinal direction of the boom 20 extends horizontally or substantially horizontally (see FIG. 2). The upper surface of the boom 20 when the boom 20 is in the collapsed posture is defined as a boom back surface 20b. The boom 20 includes a lower boom 21, a middle boom 23, and an upper boom 25. The lower boom 21 is disposed at the proximal end of the boom 20 (end on the side attached to the upper slewing body 13). The middle boom 23 is coupled to the distal end of the lower boom 21 (end on the opposite side of the side attached to the upper slewing body 13). The upper boom 25 is coupled to the distal end of the middle boom 23 and is disposed at the distal end of the boom 20. The upper boom 25 may be a substantially hexahedral member (boom head, tower cap), or a long member in the axial direction of the boom 20.

The boom derricking device 30 is a device that raises and lowers the boom 20 relative to the upper slewing body 13. The boom derricking device 30 includes a gantry 31, a boom derricking spreader 33, a boom guy line 35, a boom derricking rope 37 (rope R), and a boom derricking winch 39 (winch W).

The gantry 31 includes a compression member 31a and a tension member 31b. The compression member 31a is attached to the upper slewing body 13. The tension member 31b is connected to the distal end of the compression member 31a and the end of the upper slewing body 13 on the rear side X2.

The boom derricking spreader 33 (one example of the sheave device D described later) is a device having sheaves on which the boom derricking rope 37 is hung. The boom derricking spreader 33 includes a boom derricking lower spreader 33a (one example of support side sheave device Da described later) and a boom derricking upper spreader 33b (one example of lifting side sheave device Db described later, upper spreader). The boom derricking lower spreader 33a is a device having a sheave (for example, multiple sheaves) and is provided at the distal end of the compression member 31a. The boom derricking upper spreader 33b is a device having a sheave (for example, multiple sheaves). The boom derricking upper spreader 33b is disposed between the distal end of the compression member 31a and the distal end of the boom 20 when the crane 10 is in a working posture (posture in which work can be performed).

The boom guy line 35 is connected to the boom derricking upper spreader 33b and the distal end of the boom 20 when the crane 10 is in the working posture.

The boom derricking rope 37 (rope R) is hung on (reeved around) the sheave of the boom derricking lower spreader 33a and the sheave of the boom derricking upper spreader 33b.

The boom derricking winch 39 (winch W) is mounted in the upper slewing body 13. The boom derricking winch 39 winds and unwinds the boom derricking rope 37. Then, the distance between the boom derricking lower spreader 33a and the boom derricking upper spreader 33b changes. When the crane 10 is in the working posture, the boom derricking upper spreader 33b and the distal end of the boom 20 are connected by the boom guy line 35. Therefore, when the distance between the boom derricking lower spreader 33a and the boom derricking upper spreader 33b changes, the boom 20 rises and falls with respect to the upper slewing body 13.

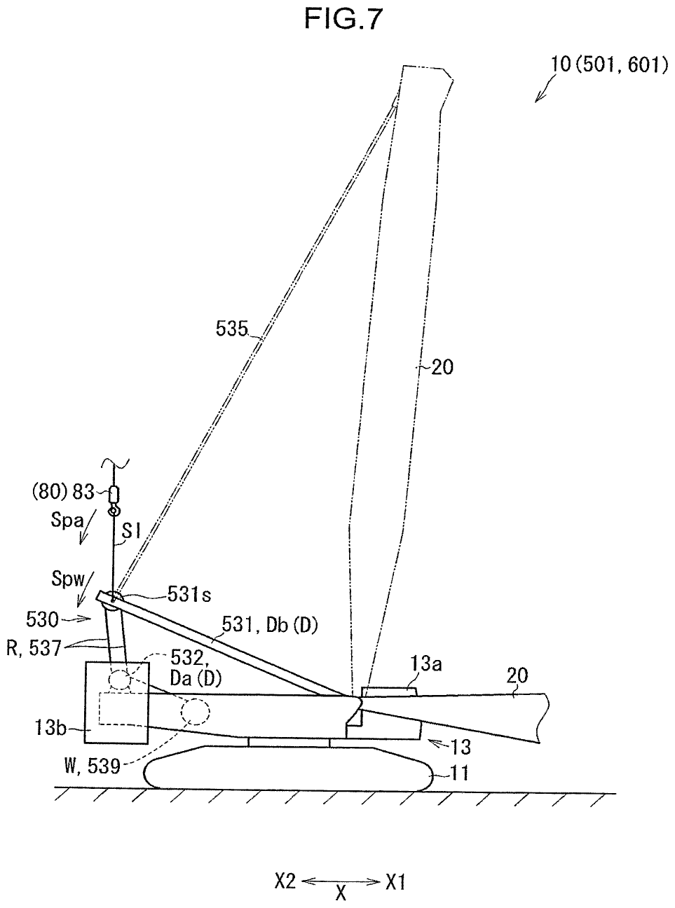

Note that the configuration of the boom derricking device 30 can be changed in various ways. For example, instead of the gantry 31, a mast 531 (see FIG. 7) (one example of lifting side sheave device Db to be described later) may be provided (described later). The boom derricking device 30 may also include the gantry 31 and the mast 531 (see FIG. 7), and may also include multiple masts 531.

### Sheave Device D, Rope R, and Winch W

The sheave device D is a device including sheaves on which the rope R is hung. The sheave device D includes the support side sheave device Da and the lifting side sheave device Db. As shown in FIG. 2, the lifting side sheave device Db is a part of the sheave device D that is lifted by the assist crane 80 when retracting and unfolding the sheave device D (described later). The support side sheave device Da is a part of the sheave device D that is different from the lifting side sheave device Db. The support side sheave device Da is a part that is held by a structure of the crane 10 (for example, gantry 31 or the like) when retracting and unfolding the sheave device D.

The rope R is hung on (reeved around) the sheave of the support side sheave device Da and the sheave of the lifting side sheave device Db to connect these sheaves.

The winch W winds and unwinds the rope R. The winch W is mounted in a structure of the crane 10 (for example, upper slewing body 13, lower boom 21, or the like). The winch W changes the distance between the support side sheave device Da and the lifting side sheave device Db by winding and unwinding the rope R, thereby causing the derricking members (for example, boom 20, jib 340, or the like shown in FIG. 1) to rise and fall. As shown in FIG. 3, the winch W includes a drum Wd and a motor Wm. The drum Wd is a member on which the rope R is wound (for example, cylindrical member). The motor Wm rotates (drives to rotate) the drum Wd with respect to the structure in which the winch W is mounted (for example, upper slewing body 13 (see FIG. 2)). The motor Wm may be, for example, a hydraulic motor or an electric motor.

A tension sensor 61 (rope state information detection unit RS) detects rope state information described later. The tension sensor 61 detects the tension of the rope R. For example, the tension sensor 61 detects force acting on the shaft of the sheave on which the rope R is hung. The “shaft of the sheave on which the rope R is hung” may be the shaft of the sheave of the support side sheave device Da, may be the shaft of the sheave of the lifting side sheave device Db, and may be the shaft of a sheave on which the rope R is hung other than the sheave device D. For example, the tension sensor 61 may detect force other than the shaft of the sheave on which the rope R is hung. The tension sensor 61 may detect, for example, a load acting on the winch W, or may detect, for example, a load acting on the shaft of the drum Wd. When the tension sensor 61 detects the load acting on the shaft, the tension sensor 61 is, for example, a load cell.

Note that the tension sensor 61 may detect the tension of the rope R by detecting a burden applied to the motor Wm. For example, when the motor Wm is a hydraulic motor, the tension sensor 61 may be a hydraulic sensor that detects hydraulic pressure that drives the motor Wm. For example, when the motor Wm is an electric motor, the tension sensor 61 may be an electric power sensor that detects electric power that drives the motor Wm. Then, the controller 71 may convert the detection value of the tension sensor 61 (hydraulic pressure, electric power, or the like) into the tension of the rope R. In this case, the controller 71 may be a part of the tension sensor 61.

A winch drive unit 63 drives the winch W. For example, when the motor Wm is a hydraulic motor, the winch drive unit 63 includes a hydraulic circuit for driving the hydraulic motor. For example, when the motor Wm is an electric motor, the winch drive unit 63 includes an electric circuit for driving the electric motor. The winch drive unit 63 is mounted, for example, in the upper slewing body 13 (see FIG. 2).

The controller 71 is a computer that performs input/output of signals, arithmetic (processing), storage of information, and the like. For example, the function of the controller 71 is implemented by executing a program stored in a storage unit (not shown) of the controller 71 in the arithmetic unit (not shown). The controller 71 may be mounted, for example, in the crane 10 (see FIG. 2), or, for example, in the upper slewing body 13 (see FIG. 2). The controller 71 may be disposed outside the crane 10 (see FIG. 2).

The notification unit 73 makes a notification to the worker (for example, operator). The contents of the notification by the notification unit 73 will be described later. The notification unit 73 may be mounted, for example, in the crane 10 as shown in FIG. 2, may be disposed, for example, inside the cab 13a, or may be disposed at a position different from the inside of the cab 13a of the crane 10. The notification unit 73 shown in FIG. 3 may be disposed outside of the crane 10 (see FIG. 2), or may be disposed, for example, in a remote control unit (not shown) for remotely controlling the crane 10. The worker to which the notification unit 73 conveys the notification may be the operator of the crane 10 (operator operating in the cab 13a or the remote control unit), the operator of the assist crane 80, a work supervisor, or another worker. The worker to which the notification unit 73 conveys the notification may be multiple persons. For example, if a worker other than the operator of the crane 10 receives the notification from the notification unit 73, the worker who receives the notification may convey (inform or the like) the content of the notification to the operator of the crane 10 (see FIG. 2) or the like (the same applies to the operator of the assist crane 80). The notification unit 73 may make a notification by light, or may perform screen display (monitor display), for example. The notification unit 73 may make a notification by sound, or may make a notification by voice, for example. The notification unit 73 may use a device normally equipped in the crane 10. Specifically, for example, the notification unit 73 may be a monitor for a moment limiter.

The assist crane 80 is a machine (auxiliary crane) separate from the crane 10 for assembling and disassembling the crane 10 shown in FIG. 2. The assist crane 80 is, for example, a mobile crane. The assist crane 80 includes an assist crane lifting load sensor 81 (see FIG. 3) (rope state information detection unit RS) and a hook 83. The assist crane lifting load sensor 81 detects the rope state information described later. The assist crane lifting load sensor 81 detects the lifting load of the assist crane 80 (described later). The hook 83 is a member on which the lifting side sheave device Db is hung. The lifting side sheave device Db is hung on the hook 83, for example, via a sling rope SI or joint (such as a shackle (not shown)). The assist crane 80 (in more detail, controller (not shown) of the assist crane 80) is configured to communicate (for example, communicate wirelessly) with the controller 71 of the crane 10 (see FIG. 3). Note that the assist crane 80 may not be included in the sheave device retracting and unfolding system 1.

### Operation

In the sheave device retracting and unfolding system 1 (in the crane 10), the work of retracting and unfolding the sheave device D (sheave device retracting and unfolding method) is performed. The work of retracting and unfolding the sheave device D is performed, for example, as part of the assembly and disassembly work of the crane 10. The work of retracting and unfolding the sheave device D includes retracting the sheave device D (for example, part of the disassembly work of the crane 10) and unfolding the sheave device D (for example, part of the assembly work of the crane 10).

Before the work of retracting and unfolding the sheave device D is performed, the assist crane 80 is in a state of lifting the lifting side sheave device Db. Here, the case where the lifting side sheave device Db is the boom derricking upper spreader 33b and the sheave device D (boom derricking spreader 33) is retracted will be described. In the state shown in FIG. 2, the boom 20 is in the collapsed posture. The distal end of the boom 20 is in the state of being supported by the ground from below. The boom derricking upper spreader 33b is disposed on the boom back surface 20b at the distal end of the lower boom 21 in a state of being detached from the boom guy line 35 (see FIG. 1). In this state, the boom derricking upper spreader 33b is lifted by the assist crane 80. The boom derricking upper spreader 33b is moved by the assist crane 80 from the boom back surface 20b at the distal end of the lower boom 21 to a position directly above or substantially directly above the gantry 31 (for example, directly above or substantially directly above the boom derricking lower spreader 33a).

### Retracting and Unfolding Sheave Device D

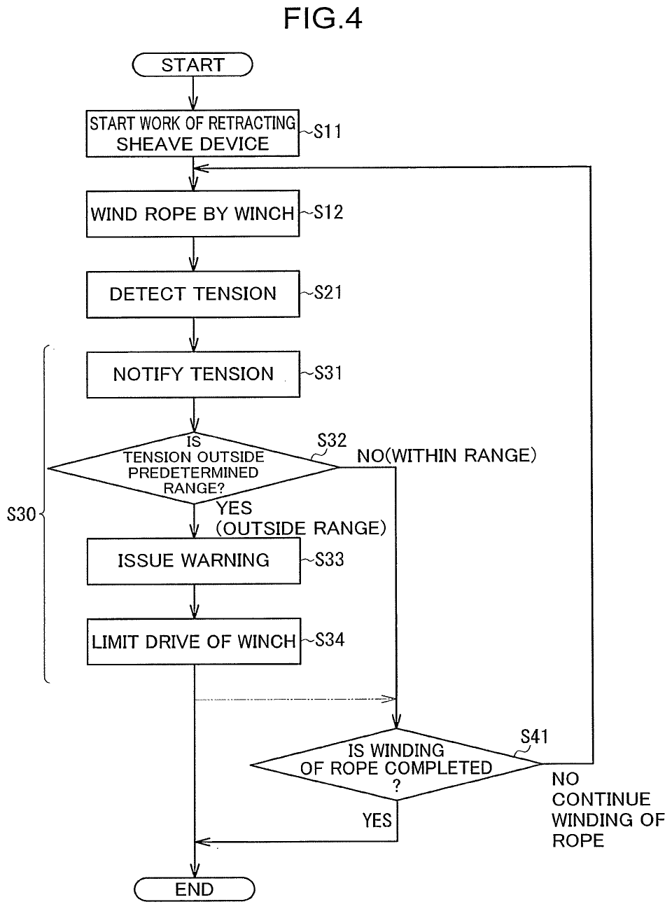

The work of retracting and unfolding the sheave device D includes, as shown in FIG. 4, work start step S11, sheave device retracting and unfolding step S12, tension information detecting step S21, tension information using step S30, and completion determination step S41.

In the following, each step (S11 to S41) will be described with reference to FIG. 4. In the work start step S11, the work of retracting and unfolding the sheave device D shown in FIG. 2 (“retracting” in FIG. 4) is started. At this time, for example, in the controller 71 (see FIG. 3), the mode of the work of retracting and unfolding the sheave device D may be set to “on”. The mode of the work of retracting and unfolding the sheave device D may be set to a retracting work mode and an unfolding work mode. For example, based on an operation by the operator (such as switch operation), the mode of the work of retracting and unfolding the sheave device D may be set to “on”. Note that the mode of the work of retracting and unfolding the sheave device D does not need to be set in the controller 71 (see FIG. 3).

In the sheave device retracting and unfolding step S12, with the lifting side sheave device Db lifted by the assist crane 80, the winch W winds and unwinds (“winds” in FIG. 4) the rope R. Specifically, for example, in response to the operation by the operator of the crane 10, the winch W winds the rope R.

At the same time the winch W winds and unwinds the rope R, the hook 83 of the assist crane 80 is wound up (moved upward) or down (moved downward). Specifically, for example, in response to the operation by the operator of the assist crane 80, the hook 83 is wound up or down.

The winch W winds and unwinds the rope R, and the hook 83 of the assist crane 80 is wound up or down. As a result, the lifting side sheave device Db moves, changing the distance between the lifting side sheave device Db and the support side sheave device Da.

### Example A1

For example, when retracting the sheave device D, at the same time the winch W winds the rope R, the assist crane 80 winds down the lifting side sheave device Db. Then, the lifting side sheave device Db approaches the support side sheave device Da, making the distance between the lifting side sheave device Db and the support side sheave device Da narrower.

### Example A2

When unfolding the sheave device D, an operation opposite to the operation when retracting the sheave device D is performed. For example, at the same time the winch W unwinds the rope R, the assist crane 80 winds up the lifting side sheave device Db. Then, the lifting side sheave device Db is separated from the support side sheave device Da, making the distance between the lifting side sheave device Db and the support side sheave device Da wider.

### Synchronization

When retracting and unfolding the sheave device D, it is important for the crane 10 and the assist crane 80 to cooperate to maintain the tension of the rope R within an appropriate range. Specifically, to maintain the tension of the rope R within an appropriate range, it is important to appropriately synchronize the winding (or unwinding) of the rope R by the winch W and the winding down (or winding up) of the hook 83 of the assist crane 80. In more detail, it is important to appropriately synchronize the speed Spw of winding (or unwinding) the rope R by the winch W and the speed Spa of winding down (or winding up) the hook 83 by the assist crane 80. If the tension of the rope R becomes excessively high or low, the following problems can occur.

When retracting the sheave device D, if the winding speed Spw of the winch W side is too fast with respect to the winding down speed Spa of the assist crane 80 side, the tension of the rope R becomes excessively high (excessive tension), which can cause the following problems.

### Example B1

If the tension of the rope R becomes excessively high, there is a risk that the sheave device D may be damaged. For example, there is a risk that at least one of the lifting side sheave device Db and the support side sheave device Da may be damaged.

### Example B2

If the tension of the rope R becomes excessively high, there is a risk that a member (lifting tool) connecting the hook 83 of the assist crane 80 to the lifting side sheave device Db may be damaged. Specifically, for example, there is a risk that the sling rope SI may be damaged (for example, cut) or the joint to which the sling rope Sl is connected (shackle (not shown) or the like) may be damaged. If the lifting tool is damaged, there is a risk that the lifting side sheave device Db may fall.

### Example B3

If the tension of the rope R becomes excessively high, there is a risk that the assist crane 80 may be damaged. For example, there is a risk that the hook 83 may be damaged. If the hook 83 is damaged, there is a risk that the lifting side sheave device Db may fall.

The same problem as in [Example B1] to [Example B3] can also occur when unfolding the sheave device D, if the unwinding speed Spw of the winch W side is too slow with respect to the winding up speed Spa of the assist crane 80 side.

When retracting the sheave device D, if the winding speed Spw of the winch W side is too slow with respect to the winding down speed Spa of the assist crane 80 side, the tension of the rope R becomes excessively low (too loose). Then, there is a risk that the rope R may become tangled in the winch W and that the rope R may come off the sheave on which the rope R is hung. These problems can also occur when unfolding the sheave device D, if the unwinding speed Spw of the winch W side is too fast with respect to the winding up speed Spa of the assist crane 80 side.

The tension of the rope R is difficult to discern from external appearance. Therefore, to suppress the problem that the tension of the rope R is excessively high or low, the sheave device retracting and unfolding system 1 performs the following operation.

In the tension information detecting step S21, the rope state information is detected when the sheave device retracting and unfolding step S12 is performed. The rope state information is information related to the tension of the rope R. The rope state information is detected by the rope state information detection unit RS (see FIG. 3).

### Example C1

The rope state information may be the tension of the rope R. In this case, for example, the tension sensor 61 (see FIG. 3) detects the tension of the rope R and outputs the detection value to the controller 71 (see FIG. 3).

### Example C2

The rope state information may be the lifting load of the assist crane 80. In this case, the assist crane lifting load sensor 81 (see FIG. 3) detects the lifting load of the assist crane 80 and outputs the detection value to the controller 71 (see FIG. 3). Specifically, for example, the lifting load detected by the assist crane lifting load sensor 81 is input to the controller of the assist crane 80 (not shown). Then, the controller of the assist crane 80 transmits (transfers) information on the lifting load to the controller 71 of the crane 10. The lifting load detected by the assist crane lifting load sensor 81 may be used as is in the tension information using step S30, or may be converted into the tension of the rope R and then used in the tension information using step S30. For example, when the load due to the mass of the lifting side sheave device Db is known in advance or can be calculated, the tension of the rope R can be calculated from the lifting load of the assist crane 80.

### Example C3

The rope state information may be information on the shape of the rope R. For example, the rope state information may be information indicating whether the rope R is in a linearly extending shape due to the tension or the rope R is in a curved (loose, slack) state. The rope state information may include information indicating the degree of curvature of the rope R. For example, the shape of the rope R may be detected by performing image processing of an image of the rope R captured by a camera (one example of rope state information detection unit RS (see FIG. 3)) or the like.

In the tension information using step S30, the process (countermeasure) to suppress the tension of the rope R from becoming excessively high is performed. In the tension information using step S30, the process (countermeasure) to suppress the tension of the rope R from becoming excessively low may be performed. Specifically, in the tension information using step S30, based on the rope state information detected in the tension information detecting step S21, at least one of notification to the worker (for example, operator of the crane 10) and drive control of the winch W is performed. The tension information using step S30 includes a tension information notification step S31, a tension determination step S32, a warning step S33, and a winch drive limit step S34.

In the tension information notification step S31, the controller 71 shown in FIG. 3 causes the notification unit 73 to notify the rope state information (“tension” in FIG. 4). The notification unit 73 may make a notification by light (such as screen display) or by sound (such as voice). The contents of the notification from the notification unit 73 in the tension information notification step S31 is as follows, for example.

### Example D1

The notification unit 73 may notify the value of the rope state information (rope tension information value). Specifically, for example, the notification unit 73 may notify the tension of the rope R detected by the tension sensor 61, may notify the lifting load detected by the assist crane lifting load sensor 81, or may notify the tension of the rope R calculated based on the lifting load. For example, the notification unit 73 may notify the value indicating the degree of curvature of the rope R.

### Example D2

The notification unit 73 may make a notification urging the worker (for example, operator of the crane 10) to properly synchronize the speed Spa of the assist crane 80 side (see FIG. 2) with the speed Spw of the winch W side (see FIG. 2). For example, the notification unit 73 may make a notification urging to decrease or increase the speed Spw of the winch W side.

In the tension determination step S32, the controller 71 determines whether the value of the rope state information (rope tension information value) detected in the tension information detecting step S21 (“tension” in FIG. 4) is within a predetermined range. The predetermined range may be a notification unnecessary range, a limit unnecessary range, or both the notification unnecessary range and the limit unnecessary range. For the above “predetermined range”, an upper limit (threshold) may be set, a lower limit (threshold) may be set, or both the upper limit and the lower limit may be set. The controller 71 may determine whether the rope tension information value has exceeded the upper limit (whether the tension is excessively high). The controller 71 may determine whether the rope tension information value is less than the lower limit (whether the tension is excessively low). The above “predetermined range” is set in advance (before this determination is made) in the controller 71. When the rope tension information value is within the predetermined range (in case of NO), the controller 71 proceeds the process flow to the completion determination step S41. When the rope tension information value is outside the predetermined range (in case of YES), the controller 71 may perform the warning step S33 or the winch drive limit step S34.

In the warning step S33, when the rope tension information value is outside the predetermined range (outside the predetermined warning unnecessary range), the controller 71 causes the notification unit 73 to issue a warning to the worker (for example, operator of the crane 10 (see FIG. 2)). The “warning” issued by the notification unit 73 is included in the “notification” made by the notification unit 73. The contents of the warning from the notification unit 73 in the warning step S33 are, for example, as follows.

### Example E1

The notification unit 73 may issue a warning regarding the rope tension information value. For example, the notification unit 73 may issue a warning that the tension of the rope R is excessively high or low. Specifically, the notification unit 73 may issue a warning that the tension of the rope R is outside the predetermined range (outside warning unnecessary range). For example, the notification unit 73 may issue a warning that the lifting load of the assist crane 80 is outside the predetermined range (outside warning unnecessary range).

### Example E2

The notification unit 73 may issue a warning to urge the operation of the winch W such that the tension of the rope R does not become excessively high or low.

### Example E2a

For example, when the speed Spw of the winch W side (see FIG. 2) is too fast with respect to the speed Spa of the assist crane 80 side (see FIG. 2), the notification unit 73 may make a notification urging to decrease the speed Spw of the winch W side or to stop the winch W. For example, when the speed Spw of the winch W side is too fast with respect to the speed Spa of the assist crane 80 side, the notification unit 73 may make a notification urging to increase the speed Spa of the assist crane 80 side.

### Example E2b

For example, when the speed Spw of the winch W side (see FIG. 2) is too slow with respect to the speed Spa of the assist crane 80 side (see FIG. 2), the notification unit 73 may make a notification urging to increase the speed Spw of the winch W side. For example, when the speed Spw of the winch W side is too slow with respect to the speed Spa of the assist crane 80 side, the notification unit 73 may make a notification urging to decrease the speed Spa of the assist crane 80 side or stop.

### Example E3

The notification unit 73 may issue a warning regarding the drive limit of the winch W in the winch drive limit step S34. For example, the notification unit 73 may issue a warning to perform drive limit of the winch W, or may issue a warning about the content of drive limit of the winch W.

In the winch drive limit step S34, when the rope tension information value is outside the predetermined range (outside predetermined limit unnecessary range), the controller 71 limits (automatically limits, controls) the drive of the winch W. At this time, the controller 71 outputs a command to the winch drive unit 63 to limit the drive of the winch W. The controller 71 limits the drive of the winch W such that the state of excessively high or low tension in the rope R is solved. For example, the controller 71 limits the drive of the winch W such that the rope tension information value fits within the predetermined range (within predetermined limit unnecessary range).

### Example F1

When the speed Spw of the winch W side (see FIG. 2) is too fast with respect to the speed Spa of the assist crane 80 side (see FIG. 2), the controller 71 performs the following control.

### Example F1a

For example, the controller 71 may decrease the speed Spw of the winch W side.

### Example F1b For example, the controller 71 may stop the winch W.

### Example F1c

For example, the controller 71 may set the upper limit value of the speed Spw of the winch W side to be lower than when the drive of the winch W is not limited (when not limited). For example, if the speed is lower than the upper limit value of the speed Spw of the winch W side, the controller 71 may drive the winch W in response to the operator's operation.

### Example F2

When the speed Spw of the winch W side (see FIG. 2) is too slow with respect to the speed Spa of the assist crane 80 side (see FIG. 2), the controller 71 performs the following control.

### Example F2a

For example, the controller 71 may increase the speed Spw of the winch W side.

### Example F2b

For example, the controller 71 may set the lower limit value of the speed Spw of the winch W side to be lower than when the drive of the winch W is not limited (when not limited). For example, when the speed is lower than the lower limit value of the speed Spw of the winch W side, the controller 71 may drive the winch W in response to the operator's operation.

When the rope tension information value is outside the predetermined range (outside the predetermined limit unnecessary range), the controller 71 may control the speed Spa of the assist crane 80 side (see FIG. 2). When the speed Spw of the winch W side (see FIG. 2) is too fast with respect to the speed Spa of the assist crane 80 side, the controller 71 may increase the speed Spa of the assist crane 80 side. Specifically, for example, the controller 71 transmits an instruction to the controller of the assist crane 80 (not shown) to increase the speed of the winch (not shown) that winds down the hook 83 (see FIG. 2). Then, the controller of the assist crane 80 increases the speed of the winch (not shown) that winds down the hook 83. When the speed Spw of the winch W side is too slow with respect to the speed Spa of the assist crane 80 side, the controller 71 may decrease the speed Spa of the assist crane 80 side.

### Relationship Between Warning Unnecessary Range and Limit Unnecessary Range

The relationship between the predetermined range for determining whether to issue a warning in the warning step S33 (warning unnecessary range) and the predetermined range for determining whether to limit the drive of the winch W in the winch drive limit step S34 (limit unnecessary range) is as follows, for example.

### Example G1

The warning unnecessary range and the limit unnecessary range may be the same range. For example, if the rope tension information value becomes outside the predetermined range, a warning may be issued in the warning step S33, and the drive limit of the winch W in the winch drive limit step S34 may be performed.

### Example G2

The warning unnecessary range and the limit unnecessary range may be different ranges. For example, the warning unnecessary range may be set within the limit unnecessary range.

### Example G2a

In more detail, the upper limit (threshold) of the warning unnecessary range may be set to be smaller than the upper limit (threshold) of the limit unnecessary range. In this case, when the rope tension information value exceeds the upper limit of the warning unnecessary range from within the warning unnecessary range, a warning is issued in the warning step S33. Then, when the rope tension information value becomes even larger and exceeds the upper limit of the limit unnecessary range, the drive limit of the winch W in the winch drive limit step S34 may be performed.

### Example G2b

The lower limit (threshold) of the warning unnecessary range may be set larger than the lower limit (threshold) of the limit unnecessary range (see [Example G2a] for details).

In the completion determination step S41, the controller 71 determines whether the work of retracting and unfolding the sheave device D has been completed (in FIG. 4, whether winding the rope R has been completed). For example, the completion of the work of retracting and unfolding the sheave device D may be determined based on the position of the support side sheave device Da shown in FIG. 2, and may be determined based on the magnitude of the distance between the support side sheave device Da and the lifting side sheave device Db. For example, the completion of the work of retracting and unfolding the sheave device D may be determined based on whether the mode of the work of retracting and unfolding the sheave device D is turned “off” in the controller 71 (see FIG. 3). When the work of retracting and unfolding the sheave device D is completed (in case of YES), the flow ends. When the work of retracting and unfolding the sheave device D is not completed (in case of NO), the flow returns to the sheave device retracting and unfolding step S12, and the drive of the winch W and the like are continued.

The completion determination step S41 is performed when the rope tension information value is within the predetermined range (in case of NO in the tension determination step S32). When the rope tension information value is outside the predetermined range (in case of YES in the tension determination step S32), the completion determination step S41 may be performed if at least one process of the warning step S33 and the winch drive limit step S34 is performed. Note that the completion determination step S41 may not be performed (controller 71 does not need to recognize that the work of retracting and unfolding the sheave device D has been completed).

### Effect of First Invention

The effect of the sheave device retracting and unfolding method in the crane 10 shown in FIG. 2 is as follows. The crane 10 includes the rope R, the winch W, and the lifting side sheave device Db. The winch W winds and unwinds the rope R. The lifting side sheave device Db includes the sheave on which the rope R is hung. The sheave device retracting and unfolding method includes the sheave device retracting and unfolding step S12 (see FIG. 4, and the same for the following steps), the tension information detecting step S21, and the tension information using step S30. The sheave device retracting and unfolding step S12 includes winding and unwinding the rope R by the winch W, with the lifting side sheave device Db lifted by the assist crane 80.

[Configuration 1] The tension information detecting step S21 includes detecting the rope state information on the rope R when the sheave device retracting and unfolding step S12 is performed. The tension information using step S30 includes performing at least one of notification to the worker and drive control of the winch W based on the rope state information detected in the tension information detecting step S21.

With the [Configuration 1], based on the rope state information, at least one of notification to the worker and drive control of the winch W is performed. When the notification to the worker (for example, tension information notification step S31, warning step S33) based on the rope state information is made, a notification to prevent the tension of the rope R from becoming excessively high can be made to the worker. As a result, it is possible to suppress the tension of the rope R from becoming excessively high when retracting and unfolding the lifting side sheave device Db. When the drive control of the winch W based on the rope state information (for example, winch drive limit step S34) is performed, the drive control of the winch W can be performed such that the tension of the rope R does not become excessively high. As a result, it is possible to suppress the tension of the rope R from becoming excessively high when retracting and unfolding the lifting side sheave device Db.

### Effect of Second Invention

### [Configuration 2] The rope state information detected in the tension information detecting step S21 is the tension of the rope R.

With the [Configuration 2], the following effect can be obtained, compared to the case where the rope state information is information indirectly indicating the tension of the rope R (for example, lifting load of the assist crane 80 or the like). It is possible to accurately perform at least one of the notification and drive control of the winch W to suppress the tension of the rope R from becoming excessively high.

### Effect of Third Invention

[Configuration 3] The tension of the rope R detected in the tension information detecting step S21 is detected by the tension sensor 61 (see FIG. 3) that detects force acting on the shaft of the sheave on which the rope R is hung.

With the [Configuration 3], it is possible to detect the tension of the rope R more accurately than, for example, in the case where the load acting on the winch W or the like is converted into the tension of the rope R, or the like. As a result, it is possible to more accurately perform at least one of the notification and drive control of the winch W to suppress the tension of the rope R from becoming excessively high.

### Effect of Fourth Invention

[Configuration 4] The rope state information detected in the tension information detecting step S21 is the lifting load of the assist crane 80.

With the [Configuration 4], the following effect can be obtained. The lifting load of the assist crane 80 is the sum of the tension of the rope R and the load due to the mass of the lifting side sheave device Db. Therefore, the lifting load of the assist crane 80 correlates with the tension of the rope R. Therefore, even if the rope state information detected in the tension information detecting step S21 is the lifting load of the assist crane 80, the same effect as in the “(Effect of first invention)” can be obtained.

When the “notification to worker” in the [Configuration 1] is made and the worker is the operator of the crane 10, the following effect can be obtained with the [Configuration 1] and [Configuration 4]. In this case, the operator of the crane 10 can be notified of the lifting load of the assist crane 80 that is different from the crane 10 being operated by the operator.

### Effect of Fifth Invention

[Configuration 5] In the tension information using step S30, when the value of the rope state information detected in the tension information detecting step S21 is outside the predetermined warning unnecessary range, a warning is issued to the worker.

With the [Configuration 5], when the value of the rope state information falls outside the warning unnecessary range, a warning is issued to the worker. As a result, when the worker who receives the warning takes an appropriate action, it is possible to suppress the tension of the rope R from becoming excessively high.

### Effect of Sixth Invention

[Configuration 6] In the tension information using step S30, when the value of the rope state information detected in the tension information detecting step S21 is outside the predetermined limit unnecessary range, the controller 71 of the crane 10 limits the drive of the winch W.

With the [Configuration 6], even when the value of the rope state information becomes outside the warning unnecessary range (when the tension of the rope R becomes excessively high), the drive of the winch W is limited. Therefore, without leaving the management of the tension of the rope R to the worker (for example, operator of the crane 10), it is possible to more reliably suppress the tension of the rope R from becoming excessively high.

### Effect of Seventh Invention

[Configuration 7] The lifting side sheave device Db includes the upper spreader (for example, boom derricking upper spreader 33b) that raises and lowers the derricking member (for example, boom 20) that is attached to the structure of the crane 10 (for example, upper slewing body 13) so as to be raisable and lowerable.

With the [Configuration 7], when the lifting side sheave device Db includes the upper spreader (for example, boom derricking upper spreader 33b), the “(Effect of first invention)” is obtained.

### Second Embodiment

Referring mainly to FIG. 2, the difference between a sheave device retracting and unfolding system 201 of the second embodiment and the first embodiment will be described. Note that the description of common points of the sheave device retracting and unfolding system 201 of the second embodiment with the first embodiment will be omitted. In the description of other embodiments described later, descriptions of common points will be omitted similarly.

In the first embodiment, as shown by the solid line in FIG. 2, with the lifting side sheave device Db (specifically, boom derricking upper spreader 33b) disposed directly above or substantially directly above the gantry 31, the work of retracting and unfolding the sheave device D has been performed. Meanwhile, the lifting side sheave device Db (specifically, boom derricking upper spreader 33b) in the present embodiment is shown by a two-dot chain line in FIG. 2. In the present embodiment, when the lifting side sheave device Db is moved between a boom back surface 20b of a lower boom 21 and a boom back surface 20b of a middle boom 23, the work of retracting and unfolding the sheave device D is performed. In this case as well, as in the first embodiment, it is possible to suppress the tension of a rope R from becoming excessively high by performing the tension information detecting step S21, the tension information using step S30, and the like.

The reason why the lifting side sheave device Db is moved between the boom back surface 20b of the lower boom 21 and the boom back surface 20b of the middle boom 23 is, for example, as follows. For example, when a crane 10 is “crane specification”, normally, the length of a boom guy line 35 (see FIG. 1) is the length from the distal end of the lower boom 21 to the upper boom 25 (distal end of the boom 20). Therefore, when attaching and detaching the boom guy line 35 to and from the boom derricking upper spreader 33b or the like, there are cases where the boom derricking upper spreader 33b is placed on the boom back surface 20b at the distal end of the lower boom 21. Meanwhile, when the crane 10 is “tower specification” or “luffing specification”, the boom guy line 35 of the above length (see FIG. 1) can cause the following problems. In this case, even if the distance between the boom derricking lower spreader 33a and the boom derricking upper spreader 33b is reduced, there are cases where the boom 20 cannot be raised to a desired angle. The above “desired angle” refers to, for example, an angle where the center axis of the boom 20 extending in the longitudinal direction of the boom 20 is perpendicular or substantially perpendicular to the ground. Therefore, there are cases where the boom guy line 35 having a length shorter than the boom guy line 35 of the above length (see FIG. 1) is used. In this case, when assembling the crane 10, there are cases where the boom derricking upper spreader 33b is moved from the retracting position (for example, boom back surface 20b at the distal end of the lower boom 21) to the attachment/detachment position for the boom guy line 35 (for example, boom back surface 20b of the middle boom 23). When disassembling the crane 10, there are cases where the boom derricking upper spreader 33b is moved from the attachment/detachment position to the retracting position. In this way, there are cases where the lifting side sheave device Db is moved between the boom back surface 20b of the lower boom 21 and the boom back surface 20b of the middle boom 23.

### Third Embodiment

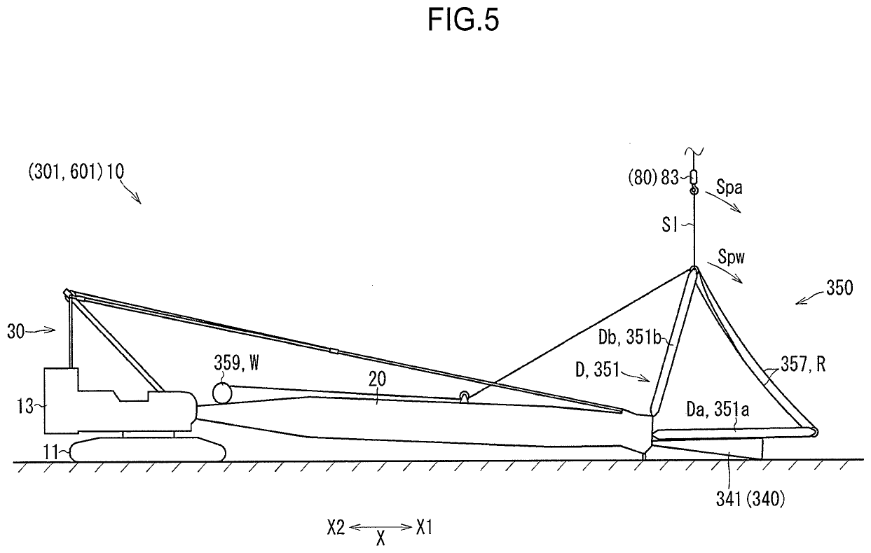

Referring mainly to FIGS. 1 and 5, the difference between a sheave device retracting and unfolding system 301 of the third embodiment and the first embodiment will be mainly described.

In the example shown in FIG. 2 (one example of the first embodiment), the sheave device D has been the boom derricking spreader 33, and the lifting side sheave device Db has been the boom derricking upper spreader 33b. Meanwhile, as shown in FIG. 5, in the present embodiment, the sheave device D is a strut 351, and the lifting side sheave device Db is a rear strut 351b. A crane 10 of the sheave device retracting and unfolding system 301 of the third embodiment includes a jib 340 and a jib derricking device 350 shown in FIG. 1.

The jib 340 (derricking member) is attached to the distal end of a boom 20 so as to be raisable and lowerable (rotatable in up-down direction). The jib 340 includes a lower jib 341, a middle jib 343, and an upper jib 345. The lower jib 341 is disposed at the proximal end of the jib 340 (end on the side attached to the boom 20). The middle jib 343 is coupled to the distal end of the lower jib 341 (end on the opposite side of the side attached to the boom 20). The upper jib 345 is coupled to the distal end of the middle jib 343 and is disposed at the distal end of the jib 340.

The jib derricking device 350 is a device that raises and lowers the jib 340 with respect to the boom 20. The jib derricking device 350 includes the strut 351, a jib guy line 353, a strut guy line 355, a jib derricking rope 357 (rope R), and a jib derricking winch 359 (winch W).

The strut 351 (sheave device D) has a sheave on which the rope R (in more detail, jib derricking rope 357) is hung. The strut 351 includes a front strut 351a and a rear strut 351b. The front strut 351a (support side sheave device Da) includes a sheave on which the rope R is hung (for example, multiple sheaves). The front strut 351a may be rotatably attached to the distal end of the boom 20 and may be rotatably attached to the proximal end of the jib 340. The front strut 351a is disposed on the upper side and front side X1 of the rear strut 351b when the crane 10 is in the posture in which work can be performed (crane posture). The rear strut 351b (lifting side sheave device Db) includes a sheave on which the rope R is hung (for example, multiple sheaves) and is rotatably attached to the distal end of the boom 20.

The jib guy line 353 is connected to the distal end of the front strut 351a and the distal end of the jib 340 when the crane 10 is in the working posture. The strut guy line 355 is connected to the distal end of the rear strut 351b and the boom 20 when the crane 10 is in the working posture.

The jib derricking rope 357 (rope R) is hung on (for example, reeved around) the sheave of the rear strut 351b and the sheave of the front strut 351a.

The jib derricking winch 359 (winch W) is mounted in the upper slewing body 13 or the boom 20 (for example, lower boom 21). The jib derricking winch 359 winds and unwinds the jib derricking rope 357. Then, the distance between the distal end of the rear strut 351b and the distal end of the front strut 351a changes. Then, the front strut 351a rises and falls with respect to the boom 20. When the crane 10 is in the working posture, the distal end of the front strut 351a and the distal end of the jib 340 are connected by the jib guy line 353. Therefore, when the front strut 351a rises and falls with respect to the boom 20, the jib 340 rises and falls with respect to the boom 20.

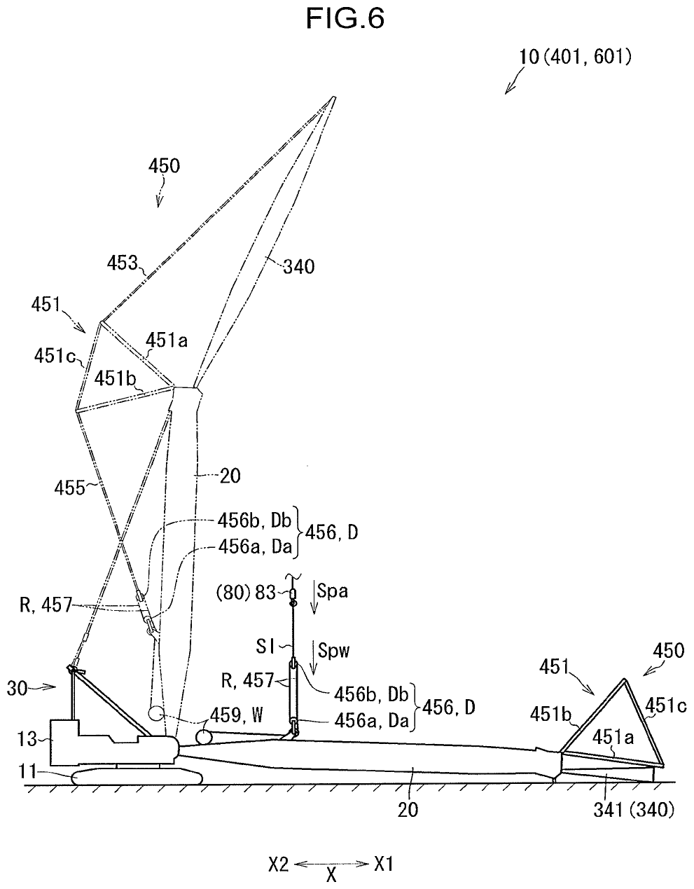

Note that the configuration of the jib derricking device 350 can be changed in various ways. For example, a strut 451 (see FIG. 6) in which the front strut 351a and the rear strut 351b are fixed to each other may be provided (described later). During the work of the crane 10, it is not necessary for the jib 340 to rise and fall with respect to the boom 20.

### Operation

The difference between the operation of the sheave device retracting and unfolding system 301 shown in FIG. 5 and the first embodiment will be described.

Before the work of retracting and unfolding the strut 351 (sheave device D) is performed, an assist crane 80 is in a state of lifting the lifting side sheave device Db (rear strut 351b). In more detail, in the state shown in FIG. 5, the boom 20 is in the collapsed posture. The jib 340 (for example, lower jib 341) is disposed to extend toward the front side X1 from the boom 20 and is, for example, in the state of being supported from below by the ground. The front strut 351a is in a lowered state and is supported from below by the lower jib 341. The front strut 351a is fixed (retracted) to the lower jib 341, for example. The rear strut 351b is in a state of being detached from the strut guy line 355 (see FIG. 1). The rear strut 351b is lifted by the assist crane 80 and is disposed to protrude upward from the distal end of the boom 20.

In the sheave device retracting and unfolding step S12 (see FIG. 4, and the same for other steps), the following operation is performed.

### Example A31

When retracting the rear strut 351b (lifting side sheave device Db), at the same time the winch W winds the rope R, the assist crane 80 winds down the distal end of the rear strut 351b while moving the distal end to the front side X1. Then, the distal end of the rear strut 351b moves to the front side X1 and down side, approaching the distal end of the front strut 351a. Then, the rear strut 351b is lowered.

### Example A32

When unfolding the rear strut 351b (lifting side sheave device Db), an operation opposite to the operation when retracting the rear strut 351b is performed. For example, at the same time the winch W unwinds the rope R, the assist crane 80 winds up the distal end of the rear strut 351b. Then, the distal end of the rear strut 351b moves to the rear side X2 and upper side, being separated from the distal end of the front strut 351a. Then, the rear strut 351b is raised.

### Synchronization

When retracting and unfolding the sheave device D (sheave device retracting and unfolding step S12), if the tension of the rope R becomes excessively high or low, the problem as in the first embodiment can occur. Furthermore, when the tension of the rope R is excessively high, the force in the direction that lifts the front strut 351a acts on the front strut 351a. Therefore, for example, problems such as damage to the fixed part between the front strut 351a and the lower jib 341 can occur. Meanwhile, in the sheave device retracting and unfolding system 301, as in the first embodiment, it is possible to suppress the tension of the rope R from becoming excessively high or low by performing the tension information detecting step S21 and the tension information using step S30.

### Effect of Eighth Invention

[Configuration 8] The effect of the sheave device retracting and unfolding method in the sheave device retracting and unfolding system 301 shown in FIG. 5 is as follows. The lifting side sheave device Db includes the strut 351 (for example, rear strut 351b) that raises and lowers the jib 340 attached to the boom 20 so as to be raisable and lowerable (see FIG. 1). With the [Configuration 8], when the lifting side sheave device Db includes the strut 351 (for example, rear strut 351b), the “(Effect of first invention)” is obtained.

### Fourth Embodiment

Referring mainly to FIG. 6, the difference between a sheave device retracting and unfolding system 401 of the fourth embodiment and the first and third embodiments will be mainly described.

The strut 351 in the example shown in FIG. 1 (one example of the third embodiment) has been designed to raise and lower the jib 340 by changing the distance between the front strut 351a and the rear strut 351b. Meanwhile, as shown in FIG. 6, in the present embodiment, a strut 451 is designed to raise and lower a jib 340 by a front strut 451a, a rear strut 451b, and a coupling member 451c integrally raised and lowered (rotated) with respect to a boom 20. In the example shown in FIG. 1 (one example of the first embodiment), the sheave device D has been the boom derricking spreader 33, and the lifting side sheave device Db has been the boom derricking upper spreader 33b. Meanwhile, as shown in FIG. 6, in the present embodiment, the sheave device D is a jib derricking spreader 456 and the lifting side sheave device Db is a jib derricking upper spreader 456b (upper spreader).

A jib derricking device 450 includes the strut 451, a jib guy line 453, a strut guy line 455, a jib derricking spreader 456, a jib derricking rope 457 (rope R), and a jib derricking winch 459 (winch W).

The strut 451 is attached rotatably to the distal end of the boom 20. The strut 451 is, for example, a triangular structure when viewed from a lateral direction. The strut 451 includes the front strut 451a, the rear strut 451b, and the coupling member 451c. The coupling member 451c couples the front strut 451a and the rear strut 451b to each other. When the jib 340 rises and falls, the distance between the front strut 451a and the rear strut 451b remains constant.

The jib guy line 453 is connected to the distal end of the front strut 451a and the distal end of the jib 340 when a crane 10 is in the working posture (as in the third embodiment). The strut guy line 455 is connected to the distal end of the rear strut 451b and the jib derricking upper spreader 456b when the crane 10 is in the working posture.

The jib derricking spreader 456 (sheave device D) includes a jib derricking lower spreader 456a (support side sheave device Da) and the jib derricking upper spreader 456b (lifting side sheave device Db, upper spreader). The jib derricking lower spreader 456a includes a sheave on which the rope R is hung (for example, multiple sheaves) and is attached to the boom 20 (for example, boom back surface 20b). The jib derricking upper spreader 456b includes a sheave on which the rope R is hung (for example, multiple sheaves). The jib derricking upper spreader 456b is disposed between the rear strut 451b and the jib derricking lower spreader 456a when the crane 10 is in the working posture.

The jib derricking rope 457 (rope R) is hung on (reeved around) the sheave of the jib derricking lower spreader 456a and the sheave of the jib derricking upper spreader 456b.

The jib derricking winch 459 (winch W) is mounted in an upper slewing body 13 or the boom 20. The jib derricking winch 459 winds and unwinds the jib derricking rope 457. Then, the distance between the jib derricking lower spreader 456a and the jib derricking upper spreader 456b changes. Then, the strut 451 rises and falls with respect to the boom 20. When the crane 10 is in the working posture, the distal end of the front strut 451a and the distal end of the jib 340 are connected by the jib guy line 453. Therefore, when the strut 451 rises and falls with respect to the boom 20, the jib 340 rises and falls with respect to the boom 20.

Note that only one strut 451 may be provided. In this case, the jib guy line 453 and the strut guy line 455 are connected to the distal end of the one strut 451.

### Operation

Before the work of retracting and unfolding the sheave device D is performed, an assist crane 80 is in a state of lifting the lifting side sheave device Db. In the state shown by the solid line in FIG. 6, the boom 20 is in the collapsed posture. The jib derricking upper spreader 456b is in a state of being detached from the strut guy line 455 (indicated by the dotted line in FIG. 6). The jib derricking upper spreader 456b is lifted by the assist crane 80. In the example shown in FIG. 6, the jib derricking upper spreader 456b is disposed directly above or substantially directly above the jib derricking lower spreader 456a.

With the jib derricking upper spreader 456b lifted by the assist crane 80, the sheave device retracting and unfolding step S12 (see FIG. 4, and the same for other steps), the tension information detecting step S21, the tension information using step S30, and the like are performed.

### Fifth Embodiment

Referring to FIG. 7, the difference between a sheave device retracting and unfolding system 501 of the fifth embodiment and the first embodiment will be mainly described.

In the example shown in FIG. 1 (one example of the first embodiment), the boom derricking device 30 has included the gantry 31. Meanwhile, as shown in FIG. 7, in the present embodiment, a boom derricking device 530 includes a mast 531 (lifting side sheave device Db).

The boom derricking device 530 includes the mast 531, a boom derricking lower spreader 532 (support side sheave device Da), a boom guy line 535, a boom derricking rope 537 (rope R), and a boom derricking winch 539 (winch W).

The mast 531 (lifting side sheave device Db) is attached to an upper slewing body 13 so as to be raisable and lowerable. The mast 531 includes a sheave on which the rope R is hung (mast sheave 531s) (for example, multiple sheaves).

The boom derricking lower spreader 532 (support side sheave device Da) is provided at the rear side X2 end of the upper slewing body 13, and includes a sheave on which the rope R is hung (for example, multiple sheaves). Note that the mast sheave 531s is included in the “upper spreader” (see the [Configuration 7]). The mast 531 (lifting side sheave device Db) and the boom derricking lower spreader 532 (support side sheave device Da) constitute the sheave device D.

The boom guy line 535 is connected to the distal end of the mast 531 and the distal end of the boom 20 when a crane 10 is in the working posture.

The boom derricking rope 537 (rope R) is hung on (reeved around) the sheave of the mast 531 (mast sheave 531s) and the sheave of the boom derricking lower spreader 532.

The boom derricking winch 539 (winch W) is mounted, for example, in the upper slewing body 13 or the like. The boom derricking winch 539 winds and unwinds the boom derricking rope 537. Then, the distance between the boom derricking lower spreader 532 and the distal end of the mast 531 changes. Then, the mast 531 rises and falls with respect to the upper slewing body 13. When the crane 10 is in the working posture, the distal end of the mast 531 and the distal end of the boom 20 are connected by the boom guy line 535. Therefore, when the mast 531 rises and falls with respect to the upper slewing body 13, the boom 20 rises and falls with respect to the upper slewing body 13.

In the sheave device retracting and unfolding step S12 (see FIG. 4), the following operation is performed.

### Example A51

When retracting the mast 531, at the same time the winch W winds the rope R, an assist crane 80 winds down the lifting side sheave device Db. Then, the distal end of the mast 531 approaches the boom derricking lower spreader 532. Then, the mast 531 is lowered with respect to the upper slewing body 13.

### Example A52

When unfolding the mast 531, an operation opposite to the operation of retracting the mast 531 is performed. For example, at the same time the winch W unwinds the rope R, the assist crane 80 winds up the lifting side sheave device Db. Then, the lifting side sheave device Db is separated from the support side sheave device Da. Then, the mast 531 is raised with respect to the upper slewing body 13.

### Sixth Embodiment

Referring to FIG. 2 and the like, the difference between a sheave device retracting and unfolding system 601 of the sixth embodiment and the first embodiment will be mainly described. The first embodiment has included a case where the controller 71 (see FIG. 3) limits the drive of the winch W to solve the state where the tension of the rope R is excessively high or low (winch drive limit step S34 (see FIG. 4, and the same for other steps)). Meanwhile, in the present embodiment, the controller 71 (see FIG. 3) automatically controls the drive of a winch W.

In more detail, in a tension information using step S30, the controller 71 (see FIG. 3) controls (automatically controls) the drive of the winch W such that the value of rope state information detected in a tension information detecting step S21 fits within a predetermined appropriate tension range. At this time, the controller 71 controls the speed of winding and unwinding a rope R by the winch W.

Specifically, for example, the controller 71 may control the drive of the winch W according to the position of a lifting side sheave device Db. Specifically, for example, the position of the lifting side sheave device Db with respect to the ground, a structure of a crane 10 (for example, upper slewing body 13), or the like may be detected. Then, for example, the controller 71 may calculate the appropriate position range for the lifting side sheave device Db according to the winding amount of the rope R or the like. When the tension of the rope R is excessively high or low, the position will be outside the appropriate position range for the lifting side sheave device Db. Therefore, the controller 71 may control (automatically control) the speed of winding and unwinding the rope R by the winch W such that the lifting side sheave device Db is disposed within the appropriate position range.

For example, the controller 71 may control the drive of the winch W according to the tension of the rope R. Specifically, for example, the controller 71 may determine whether the speed Spw of the winch W side has changed to a faster side or slower side with respect to the speed Spa of an assist crane 80 side based on the change in the tension of the rope R. Then, when the speed Spw of the winch W side changes to a faster side with respect to the speed Spa of the assist crane 80 side, the controller 71 may perform control to change the speed Spw of the winch W side to a slower side. For example, when the speed Spw of the winch W side changes to a slower side with respect to the speed Spa of the assist crane 80 side, the controller 71 may perform control to change the speed Spw of the winch W side to a faster side.

The “appropriate tension range” is set, for example, in the controller 71 (see FIG. 3) in the same manner as the “limit unnecessary range”. Both the limit unnecessary range and the appropriate tension range may be set in the controller 71. The appropriate tension range may have a narrower range than the limit unnecessary range. In more detail, if an upper limit is set for the appropriate tension range, the upper limit for the appropriate tension range may be set lower than the upper limit for the limit unnecessary range. If a lower limit is set for the appropriate tension range, the lower limit for the appropriate tension range may be set higher than the lower limit for the limit unnecessary range.

The controller 71 (see FIG. 3) may control (automatically control) the drive of the winch (not shown) that winds up and down the hook 83 of the assist crane 80 such that the value of the rope state information falls within the predetermined appropriate tension range. Specifically, for example, the controller 71 transmits a command for controlling the winch of the assist crane 80 to the controller of the assist crane 80 (not shown). Then, the controller of the assist crane 80 may control the winding up and down of the hook 83 of the assist crane 80.

### Effect of Ninth Invention

[Configuration 9] The effect of the sheave device retracting and unfolding method in the sheave device retracting and unfolding system 601 shown in FIG. 2 is as follows. In the tension information using step S30, the controller 71 of the crane 10 (see FIG. 3) controls the drive of the winch W such that the value of rope state information detected in the tension information detecting step S21 fits within the predetermined appropriate tension range.

With the [Configuration 9], the winch W is controlled such that the value of the rope state information fits within the appropriate tension range. Therefore, without leaving the management of the tension of the rope R to the worker (for example, operator of the crane 10), it is possible to more reliably suppress the tension of the rope R from becoming excessively high.

### Modifications

The above embodiments may be variously modified. For example, components of embodiments different from each other may (including modifications) be combined. For example, the number of components of the above embodiments may be changed, and some of the components do not have to be provided. For example, modifications of the above embodiments may be variously combined. For example, the components may be fixed or connected directly or indirectly. For example, the connection of each component shown in FIG. 3 may be changed. For example, an inclusion relationship of the components may be variously changed. For example, a component described as a lower component included in a certain higher component is not required to be included in the higher component, and may be included in another component. For example, a plurality of members and parts different from each other may be described as one member and part. For example, what has been described as one member and part may be divided into a plurality of different members and parts. For example, various parameters (threshold, range, or the like) may be preset in the controller 71, or may be directly set by manual operation of the worker. For example, the various parameters may not be changed, may be changed by manual operation, or may be automatically changed by the controller 71 according to some condition. For example, the order of the steps in the flowchart shown in FIG. 4 may be changed, and some of the steps need not be performed. For example, the components each may have only some of the characteristics (operating function, arrangement, shape, operation, or the like).

1. A sheave device retracting and unfolding method for a crane including a rope, a winch that winds and unwinds the rope, and a lifting side sheave device including a sheave on which the rope is hung, the sheave device retracting and unfolding method comprising:
a sheave device retracting and unfolding step of winding and unwinding the rope by the winch, with the lifting side sheave device lifted by an assist crane;
a tension information detecting step of detecting rope state information on the rope when the sheave device retracting and unfolding step is performed; and
a tension information using step of performing at least one of notification to a worker and drive control of the winch based on the rope state information detected in the tension information detecting step.

2. The sheave device retracting and unfolding method according to claim 1, wherein the rope state information detected in the tension information detecting step is tension of the rope.

3. The sheave device retracting and unfolding method according to claim 2, wherein the tension of the rope detected in the tension information detecting step is detected by a tension sensor that detects force acting on a shaft of the sheave on which the rope is hung.

4. The sheave device retracting and unfolding method according to claim 1, wherein the rope state information detected in the tension information detecting step is a lifting load of the assist crane.

5. The sheave device retracting and unfolding method according to claim 1, wherein the tension information using step includes issuing a warning to the worker when a value of the rope state information detected in the tension information detecting step is outside a predetermined warning unnecessary range.

6. The sheave device retracting and unfolding method according to claim 1, wherein the tension information using step includes limiting the drive of the winch by a controller of the crane when the value of the rope state information detected in the tension information detecting step is outside a predetermined limit unnecessary range.

7. The sheave device retracting and unfolding method according to claim 1, wherein the lifting side sheave device is an upper spreader that raises and lowers a derricking member attached, so as to be raisable and lowerable, to a structure of the crane.

8. The sheave device retracting and unfolding method according to claim 1, wherein the lifting side sheave device is a strut that raises and lowers a jib attached, so as to be raisable and lowerable, to a boom.

9. The sheave device retracting and unfolding method according to claim 1, wherein the tension information using step includes the controller of the crane controlling the drive of the winch such that the value of the rope state information detected in the tension information detecting step falls within a predetermined appropriate tension range.
